(19) United States
(12) Patent Application Publication
(10) Pub. No.: US 2021/0195308 A1
(43) Pub. Date: Jun. 24, 2021

(54) Earbuds With Enhanced Features

(71) Applicant: SONIPHI LLC, Incline Village, NV (US)

(72) Inventors: Deric SOLIS, Santa Rosa, CA (US); Matthew SANDERSON, Incline Village, NV (US); James MCCLANANHAN, Greenwood Village, CO (US); Wayne POWELL, Centennial, CO (US)

(21) Appl. No.: 17/271,894

(22) PCT Filed: Aug. 29, 2019
(86) PCT No.: PCT/US19/48744

§ 371 Date: Feb. 26, 2021

Related U.S. Application Data
(60) Provisional application No. 62/724,544, filed on Aug. 29, 2018.
(60) Provisional application No. 62/724,536, filed on Aug. 29, 2018.
(60) Provisional application No. 62/724,601, filed on Aug. 29, 2018.
(60) Provisional application No. 62/724,573, filed on Aug. 29, 2018.
(60) Provisional application No. 62/724,556, filed on Aug. 29, 2018.

(51) Int. Cl. H04R 1/10; H04R 1/24; H04R 1/28; H01F 27/00

(52) U.S. Cl. CPC H04R 1/1016; H01F 27/006; H04R 1/2811; H04R 1/24

(57) ABSTRACT

Earbuds with one or more enhanced features, including sound quality, perceived auditory effects, audio control, and user interface. Sound quality is improved using multiple speakers and isobaric chambers. Additional speaker and isobaric chamber can be in an ear hook. Elongated scalar coils modify or enhance the audio quality of an earbud and its auditory effects on a user. A users voice is utilized to record and to generate a user-specific audio filter that is applied to stored audio files to generate modified audio files. An earbud can include an array of capacitive sensors arranged on a stem extending from the earbud. An earbud device can also have a user interface that incorporates a rotary switch that is part of a stem that extends from the main body of the earbud. The interface can include a pressure switch positioned on the stem.

This application claims the benefit of priority to U.S. Patent Provisional Applications No. 62/724,536, No. 62/724,544, No. 62/724,556, No. 62/724,573, and No. 62/724,601, filed on Aug. 29, 2018, to U.S. patent application Ser. No. 16/552,030, filed on Aug. 27, 2019, and to U.S. patent application Ser. No. 16/553,391, Ser. No. 16/553,472, Ser. No. 16/553,653, and Ser. No. 16/553,752, filed on Aug. 28, 2019. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FEILD OF THE INVENTION

The field of the invention is earbuds.

### BACKGROUND

The following description includes information that may be useful in understanding the present invention. It is not an admission that any of the information provided herein is prior art or relevant to the presently claimed invention, or that any publication specifically or implicitly referenced is prior art.

Earbud-style headphones are popular among users because they are generally small and portable. Conventional portable audio systems typically include a pair of headphones or earbuds, which connect to a portable media player (either through a wired connection or wirelessly). With the increasing popularity of earbuds and the increase in advanced audio functionality available to current devices, the corresponding benefits of using the advanced audio functionality to improve the audio characteristics of earbuds have yet to be fully realized.

One challenge faced by earbuds is that they tend to have lower sound quality due to its smaller size compared to conventional loud speakers. Prior work teaches isobaric chambers for a traditional loudspeaker. For example, U.S. Pat. No. 4,008,374 to Tiefenbrun et al. teaches a bass unit for a loudspeaker system which has a pair of loudspeakers mounted one behind the other in a casing to define a chamber of air therebetween. U.S. Pat. No. 5,701,358 to Larson et al teach an isobaric loudspeaker for use in audio systems. U.S. Pat. No. 6,816,598 to Budge teaches a loudspeaker with reduced impedance and improved response. However, these designs for a loudspeaker are not suitable for a much smaller earbud that has a special shape designed to be worn in a user's ear.

U.S. Pat. No. 9,949,014 to Cramer et al teaches a wireless pair of earbuds having an ear hook coupled with the earbud body and configured to fit around a root of an ear pinna of the user. However, it does not teach how to improve the sound quality in the earbud speaker. Moreover, conventional earbuds and audio devices do not incorporate advanced audio signal manipulation techniques (e.g., scalar coils) to improve the electromagnetic signal arriving at the speaker to enhance the audio quality. Conventional earbuds also do not use light-based techniques (e.g., photonic boom principle) to enhance auditory effects.

In addition, earbud performance remains to be enhanced for a specific user by adjusting the frequency distribution of outputted audio files. This is typically performed by either manual adjustment via software that emulates an audio equalizer or by selection from a set of predetermined audio settings. Such predetermined settings, however, may not provide a sufficient range of choices for all users. Similarly, manual adjustment is time consuming and may not be suitable for all users. Attempts have been made to address these issues by adjusting audio settings based on data provided by the headset. For example, U.S. Pat. No. 10,299,029, to Aase, describes a system in which data from earbud pressure sensors are used to determine the size and shape of a user's ear, which are in turn used to adjust volume levels within different frequency ranges for a particular user. Similarly, U.S. Pat. No. 10,334,347, to Kofman and Klemme, describes a system in which data from a capacitance-based sensor is used to determine position of an earbud within the ear to adjust audio output of the earbud. Such approaches, however, cannot take into account subjective hearing differences due to damage to the middle ear, inner ear, or portions of the brain utilized for audio processing.

Another emerging issue is how to allow a user to effectively control media playback using a small user interface. The use of conventional buttons in small playback devices requires a high degree of targeted button presses in particular patterns. As such, conventional media playback control mechanisms are difficult to use with precision and simplicity. U.S. Pat. No. 7,925,029, to Hollemans and Buil, describes a personal audio system that includes a touch sensitive area. Commands are provided to the device through detection of temporal patterns of contact on this touch sensitive area. Such an approach, however, requires physical contact with the device. Such contact can interfere with placement and positioning of the touch sensitive area, as such contact could displace a small device to which it is coupled. U.S. Pat. No. 10,110,987, to Yamkovoy, describes a method for controlling an audio system in which pressure changes within the ear canal of a user in response to contact with a headphone are detected. Such a method, however, relies on using a headphone that forms a tight seal with the ear or walls of the ear canal (which can cause comfort issues) and assumes that a user has properly inserted the device.

U.S. Pat. No. 10,117,012, to Saulsbury and McQueen, describes an earbud that includes proximity sensor circuitry. Among the various embodiments described are devices that use such a proximity sensor based on capacitance. A related approach is described in U.S. Pat. No. 10,334,347, to Kofman and Klemme, in which a complex capacitive sensor with an exposed trace is used to determine positioning of the earbud within an ear canal of a user. Similarly, U.S. Pat. No. 10,291,975, to Howell et al., describes wireless earbuds equipped with optical proximity sensors. Data from such sensors is used to indicate that status or position of the earbud (i.e. placed within the ear, resting within a case, covered by a protective device, etc.). Such approaches, however, do not provide control over functions of the device.

Yet another problem associated with earbuds is that a small user interface does not allow a user to effectively control media playback. The use of conventional buttons in small playback devices requires a high degree of targeted button presses in particular patterns. Alternatively, some earbud devices use patterns in data obtained from accelerometers imbedded in the earbud to allow a user to perform rudimentary tasks by tapping. Such accelerometers, however, are also affected by other movements, such as impact on walking, turning of the head, etc., and require sophisticated data filtering to avoid false inputs. As such, conventional media playback control mechanisms are difficult to use with precision and simplicity. U.S. Pat. No. 8,340,338 (to Mlodzikowski et al.) describes an earbud device that includes a relatively large rotatable feature on the device's main body, which projects outward from the ear when worn. Rotation of this feature applies mechanical pressure to an internal mechanism that expands the portion of the earbud that is inserted into the ear canal, which in turn provides a secure fit.

Thus, there is still a need for earbuds with improved sound quality, functionality, audio control, physical user interface, and auditory effects on a user.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which one or more aspect of an earbud is enhanced, including sound quality, functionality, audio control, physical user interface, and auditory effects on a user.

In some embodiments, contemplated earbuds have a housing (i.e., “main body”) having at least a first sound driver with a first isobaric chamber, a second sound driver with a second isobaric chamber, and a sound outlet that is in communication with the first and second isobaric chambers. In preferred embodiments, each sound driver is advantageously positioned to emit sound waves to its corresponding isobaric chamber. In especially preferred embodiments, a divider at least partially separates the second isobaric chamber into a first portion and a second portion. Sound waves emitted from the second sound driver travel away from the sound outlet in the first portion, and towards the sound outlet in the second portion. As used herein, “driver” and “speaker” are used interchangeably.

In preferred embodiments, the first sound driver is configured to emit sound waves in the middle frequency range and the treble frequency range, and the second sound driver is configured to emit sound waves in the bass frequency range. As used herein, “treble” refers to tones whose frequency or range is at the higher end of human hearing, i.e., having frequencies from 2048 to 16384 Hz (C7-C10); “bass” means tones of low (i.e., “deep”) frequency, pitch and range from 16 to 256 Hz (C0 to middle C4); and “middle” refers to ranges between treble and base.

In preferred embodiments, the second sound driver is larger than the first sound driver, and the second isobaric chamber is larger than the first isobaric chamber. For example, the second isobaric chamber can be at least 2 times, 4 times, 6 times, or 8 times larger than the first isobaric chamber. In especially preferred embodiments, the first sound driver is a piezo type driver that does not have a magnet. The first and second speakers can be arranged in any suitable position relative to each other, for example, cone to magnet (preferred), magnet to magnet, or cone to cone.

In some embodiments, the earbud has an ear hook coupled to the housing. The ear hook is sized and shaped to engage a portion of a user's outer ear. In preferred embodiments, the ear hook has a third isobaric chamber and a third sound driver positioned to emit sound waves into the third isobaric chamber. The third isobaric chamber is in communication with the outlet through the second isobaric chamber. In especially preferred embodiments, the housing comprises a circular section surrounding a portion of the second isobaric chamber and having an opening where the third isobaric chamber joins the second isobaric chamber.

In some embodiments, a scalar coil is used to modify or enhance the audio quality and of a speaker system and its auditory effects on the user. The contemplated speaker system can include a speaker and an elongated coil coupled to the speaker. In preferred embodiments, the elongated coil is a scalar coil. As used herein, a “scalar coil” refers to a single strand of coil that has at least two segments of spiral winding, where the second segment winds in an opposite direction to the first segment, when viewed from the wider end of the first segment. As used herein, “spiral winding” refers to winding in a continuous and gradually widening curve, about a center axis to form at least a partial cone.

For example, a first spiral winding can be wound in a clockwise direction (when viewed from the wider end of the first spiral winding), and a second spiral winding can be wound in a counterclockwise direction (also viewed from the wider end of the first spiral winding). Alternatively, a first spiral winding can be wound in a counterclockwise direction (when viewed from the wider end of the first spiral winding), and a second spiral winding can be wound in a clockwise direction (also viewed from the wider end of the first spiral winding). In especially preferred embodiments, a first elongated coil is arranged in series with an input of the speaker, and the first spiral winding shares a center and a center axis with the second spiral winding.

In some embodiments, the contemplated speaker system can include a light emitting device and an elongated coil coupled to the laser emitting device. Suitable light emitting devices include, but are not limited to, lasers, LEDs, and solid-state lasers. In preferred embodiments the light emitting device is a laser or solid-state laser. The elongated coil coupled to the light emitting device is similar or identical to the elongated coil coupled to the speaker described above. It is contemplated that the light emitting device is positioned and oriented such that an emitted light beam travels through the elongated coil coupled to the light emitting device. In preferred embodiments, the speaker system has a housing with an outlet that is transparent to sound waves and to electromagnetic radiation. It is contemplated that the light beam travels through the elongated coil before passing through such an outlet. In especially preferred embodiments, the outlet is an opening in the housing (such as an aperture or through-hole).

In preferred embodiments, the contemplated speaker systems have an elongated coil coupled to the speaker, and a second elongated coil coupled to a light emitting device. The speaker system can be any size and designed to use in any environment. Contemplated speaker systems include an earbud, an earphone, stereo system in a car, a home, a movie theater, etc. The speaker system can be connected to an audio output through a wire or by a wireless system (e.g., WiFi, Bluetooth™).

Inventors have found that scalar coils can modify the sound signature of audio feed through the scalar coil, for example by removing high-frequency audio artifacts typical of decompressed digital sound signals. Without wishing to be bound by theory, the Inventors believe that this reduction in digital noise is accomplished by reflection of electromagnetic forces back against themselves in the scalar coil assembly, which in turn causes the energy of the higher frequency components (e.g., ultrasonic) to cancel each other out. The measured benefit is that this scalar coil tends to reduce high frequency edging associated with digital processing (such as decompression) of audio signals (e.g., MP3 files, Bluetooth audio signals, etc.). This benefit is accomplished by inserting a scalar coil in the sound path of the loudspeakers being connected to the voice coils/armatures coils of the various drivers. It is contemplated that scalar coils can passively alter an audio signal to remove high frequencies associated with digital sound signals. This is especially advantageous in removing unwanted noises from audio sources, including, for example, static and sibilance.

Scalar coils also produce electromagnetic forces that influence animal physiology by stimulating the vagus nervous system to improve perceived audio quality when exposed to laser light and a photonic boom that accompanies passage through a device as described above. In some embodiments, the scalar coils can be mounted to guide the energy of a laser beam through the coil assembly producing a photonic reaction with the coil creating a dispersion of the energy to the wearer of the earbud to cause subliminal perception (e.g., low order stimulus to the nervous system.). When combined with a laser, the audio quality benefits of using a scalar coil can be enhanced by generating a photonic boom, which the Inventors believe can directly and/or indirectly interact with human cells to improve perceived audio quality. Additionally, when a laser passes through the scalar coil along the axis, the deflection of the photons by the scalar coil causes changes in the electromagnetic field near a user associated with the audio, thereby further improving perceived audio quality. However, it is contemplated that the laser can pass through the scalar coil at any angle that can change the actual audio quality and/or the perceived audio quality to a user.

The inventive subject matter also provides apparatus, systems and methods in which vocal data collected from a user is utilized to generate a user-specific audio filter that reflects characteristics of the user's hearing. This user-specific audio filter is then utilized to modify existing audio files, generating audio files that are customized to improve the user's listening experience.

One embodiment of the inventive concept is a method for enhancing audio quality of earbuds by receiving and recording a voice communication from a user, transforming the voice communication into vocal data using a Fast Fourier Transform analysis and/or Fractal analysis, determining a unique vocal feature associated with the user to create a user specific audio profile from the vocal data; and creating a user specific audio configuration for the user associated with the user specific audio profile. In some embodiments the method can also modify a stored audio file using the user specific audio profile to generate a user customized audio file. In some embodiments this process can be repeated using a second voice communication from the user to generate a set of updated vocal features, which are in turn used to update or replace an earlier generated audio profile. This updated audio profile can be used to generate a new or improved modified audio file.

Another embodiment of the inventive concept is a personal audio system that includes an earbud having a microphone and a speaker (where the microphone is positioned to receive vocal sounds from a user), a first audio processor that is in communication with the microphone and that has stored instructions for performing a Fourier Transform analysis and/or Fractal analysis on vocal data received from the microphone to generate a user specific audio profile from the vocal data, a first database that is in communication with the first audio processor and that includes the user specific audio profile, and a second audio processor that includes stored instructions for modifying an audio file using the user specific audio profile to generate a user customized audio file, wherein the second audio process is communicatively coupled to the speaker. In some embodiments the earbud includes the first audio processor. In such embodiments the second audio processor can be positioned in an audio player that is distinct from but is communication with the earbud. Such an audio player can include a second database that includes one or more audio files.

In some embodiments, an earbud is provided with a capacitance-based proximity sensor that is utilized to provide control function to a media player that is in communication with the earbud. One embodiment of the inventive concept is a capacitive control interface for earbuds that includes an earbud stem, a capacitive sensor coupled to the earbud stem and configured to allow control over one or more functions of the earbud, and a processor or microcontroller communicatively coupled to the capacitive sensor that has one or more program instructions (such as a fast forward instruction, a rewind instruction, a skip forward instruction, and a skip backward instruction) that are executable in response to data from the capacitive sensor. The capacitive sensor can be an array that has two or more capacitor elements, which can be arranged as a one- or two-dimensional array. In a preferred embodiment these capacitor elements are arranged as a bucket brigade circuit. Capacitor elements of such an array can differ in size and/or shape (e.g. at least one dimension) and can differ in composition from one another. In some embodiments the processor is also in communication with a light source.

Another embodiment of the inventive concept is an earbud that includes a shell having a body and a stem extending from the body, a capacitive sensor coupled to the earbud stem and configured to allow control over one or more functions of the earbud, and a processor or microcontroller communicatively coupled to the capacitive sensor that has one or more program instructions (such as a fast forward instruction, a rewind instruction, a skip forward instruction, and a skip backward instruction) that executable in response to data from the capacitive sensor. The capacitive sensor can be an array that has two or more capacitor elements, which can be arranged as a one- or two-dimensional array. In a preferred embodiment these capacitor elements are arranged as a bucket brigade circuit. Capacitor elements of such an array can differ in size and/or shape (e.g.at least one dimension) and can differ in composition from one another. In some embodiments the processor is also in communication with a light source.

Certain embodiments of the inventive concept also provide a control interface for an earbud (such as an earbud that forms all or part of a personal entertainment system), where the earbud includes a rotary switch that acts as a user interface for a processor or controller that controls functions of the earbud. In preferred embodiments the earbud also includes a pressure switch that provides additional or complementary control functions.

One embodiment of the inventive concept is a control interface for an earbud, that includes an earbud having a stem and a processor; a rotary switch coupled to the stem and electronically coupled to the processor, and a pressure switch that is electronically coupled to the processor. The processor is configured to execute one or more program instructions in response to electrical signals from the rotary switch and/or the pressure switch. In some embodiments the pressure switch is positioned on or in stem. For example, the stem can include a pressure sensitive portion that acts as the pressure switch, or the rotary contact switch can include or act as the pressure switch. Program instructions include one or more of a power on instruction, a power off instruction, a sleep instruction, a volume modulation instruction, a fast forward instruction, a rewind instruction, a skip forward instruction, and a skip backward instruction. In some embodiments input from the pressure switch activates a power on instruction, a power off instruction, and/or a sleep instruction. In some embodiments a signal received by the processor from the rotary switch activates a volume modulation instruction, a fast forward instruction, a rewind instruction, a skip forward instruction, and a skip backward instruction.

Another embodiment of the inventive concept is an earbud that includes a housing having a stem and enclosing a processor, a pressure switch electronically coupled to the processor, and a rotary switch coupled to the stem and electronically coupled to the processor. The processor incorporates one or more program instructions that are executable to control functions of the earbud. The pressure switch can be positioned on or in the stem. For example, the stem can have a pressure sensitive portion that acts as the pressure switch, or the rotary contact switch can incorporate or act as the pressure switch. Program instructions of the processor can include a power on instruction, a power off instruction, a sleep instruction, a volume modulation instruction, a fast forward instruction, a rewind instruction, a skip forward instruction, and/or a skip backward instruction. In some embodiments a signal received by the processor from the pressure switch activates a power on instruction, a power off instruction, and/or a sleep instruction. In some embodiments a signal received by the processor from the rotary switch activates a volume modulation instruction, a fast forward instruction, a rewind instruction, a skip forward instruction, and/or a skip backward instruction.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A to 1C depict various views of an earbud of the inventive concept. FIG. 1A shows an embodiment of a contemplated earbud having two isobaric chambers. FIG. 1B shows a cross-sectional view of the embodiment in FIG. 1A along plane A-A. FIG. 1C shows a cross-sectional view of the embodiment in FIG. 1A along plane B-B.

FIGS. 2A to 2C depict various views of an alternative earbud of the inventive concept. FIG. 2A shows an embodiment of a contemplated earbud having two isobaric chambers and an ear hook having a third isobaric chamber. FIG. 2B shows a cross-sectional view of the embodiment in FIG. 2A along plane A-A.

FIGS. 3A and 3B depict features of an earbud of the inventive concept. FIG. 3A shows an embodiment of a speaker system having a shape of an earbud, where a scalar coil is in series with the speaker. FIG. 3B shows a preferred embodiment of a scalar coil in FIG. 3A.

FIG. 4 shows a preferred embodiment of a speaker system having speaker and a laser emitter, both coupled to a scalar coil.

FIG. 5 shows another preferred embodiment of speaker system similar to that in FIG. 4, but the laser is now being guided by a set of reflectors.

FIG. 6 is a schematic of a method analyzing a voice recording and creating a unique audio profile.

FIG. 7 schematically depicts a system of the inventive concept having an earbud and an audio player.

FIG. 8 schematically depicts an earbud embodiment having a capacitive touch sensor that provides input to a processor and serves to provide a control mechanism.

FIG. 9 provides a schematic depiction of an earbud having control mechanisms in the form of rotary and pressure switches.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

An earbud of the inventive concept can include a housing or body that is in contact with and/or at least partially inserted into an ear of a user when in use. Such a housing can be constructed of one or more materials suitable for contact with human skin, and can have different compositions in different regions of the housing. For example, portions of the housing that are exposed when in use can be constructed of one or more rigid materials (e.g. hard plastic, metal, ceramic, etc.) whereas portions that are inserted into the ear canal can be constructed of one or more pliant materials (e.g. silicone rubber, latex, polyurethane, etc.). In some embodiments an earbud of the inventive concept can include a hook or similar projection that engages with the concha of the ear, improving stability and proper positioning of the earbud. The housing of the earbud can also support one or more control features that can be used to control earbud functions. In a preferred embodiment a portion of the body or housing can extend downwards in a stem or stalk.

Such an earbud can include a power supply (such as a battery) and one or more speakers, and is in communication with a source of audio and/or video files for playback through the earbud. Such audio and/or video files can be stored on memory within the earbud, or can be stored on memory in an external device (such as a computer, telephone, or portable audio player). In embodiments where audio and/or video files are stored in an external device the earbud can include an antenna, circuitry, and appropriate processing to support wireless communication (e.g. BlueTooth, WiFi, etc.). Alternatively or in addition to such wireless circuitry, and earbud of the inventive concept can include a port that supports a wired connection. Earbuds of the inventive concept can also include an antenna and associated circuitry to support wireless charging of an onboard power supply, for example by magnetic induction.

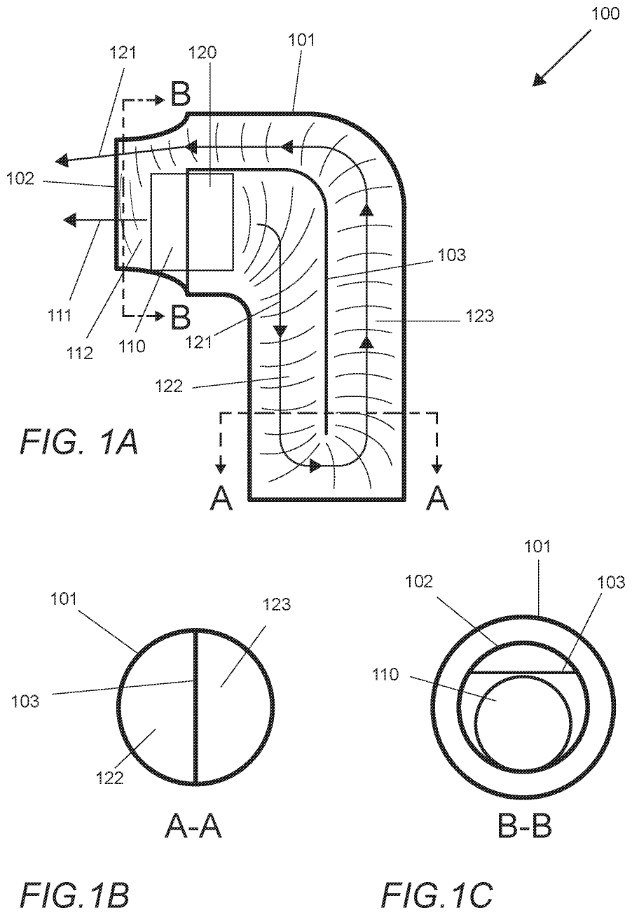

In FIG. 1A, an earbud 100 has a housing 101 with a sound outlet 102, a first sound driver 110 emitting a first soundwave 111 traveling through a first isobaric chamber 112 and then outside the housing 101 through the outlet 102, and a second sound driver 120 emitting a second soundwave 121 traveling through a second isobaric chamber (122 and 123) and then outside the housing 101 through the outlet 102. A divider 103 partially separates the second isobaric chamber into a first portion 122 and a second portion 123. The second sound wave 121 travels in the first portion 122 away from the outlet 102 and then in the second portion 123 towards the outlet 102. FIG. 1B shows the divider 103 divides the second isobaric chamber into a first portion 122 and a second portion 123. FIG. 1C shows the divider 103, the first sound driver 110, and the outlet 102.

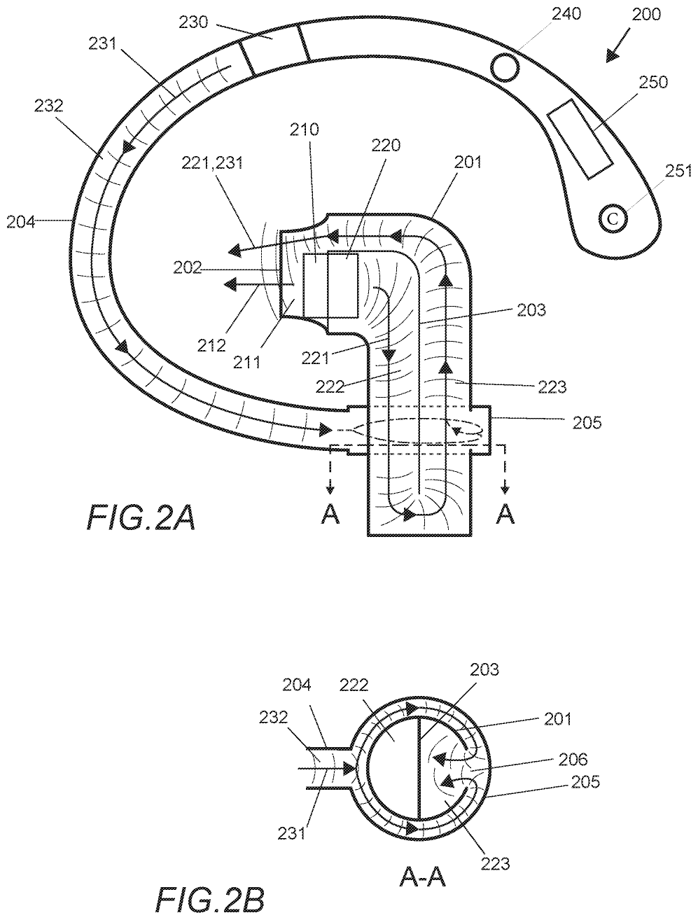

In FIG. 2A, an ear hook 204 is coupled to the housing 201 having a sound outlet 202. The housing 201 has a first sound driver 210 emitting a first soundwave 211 travelling through a first isobaric chamber 212 and then outside the housing 201 through the outlet 202, and a second sound driver 220 emitting a second soundwave 221 travelling through a second isobaric chamber (222 and 223) and then outside the housing 201 through the outlet 202. A divider 203 partially separates the second isobaric chamber into a first portion 222 and a second portion 223. The ear hook 204 has a third sound driver 230 positioned to emit a third sound wave 231 into the third isobaric chamber 232. Sound wave 231 travels through the third isobaric chamber 232, and then through a portion of the isobaric chamber 232, and then outside the housing 201 through the outlet 202. The third sound driver 230 is preferably a subwoofer armature. The third isobaric chamber 232 is in communication with the outlet 202 through the second isobaric chamber (222 and 223). The housing 201 has a circular section 205 surrounding a portion of the second isobaric chamber (222 and 223). FIG. 2B shows the divider 203 divides the second isobaric chamber (222 and 223) into a first portion 222 and a second portion 223, and the third isobaric chamber 232 joins the second portion 223 of the second isobaric chamber at an opening 206 of the housing 201.

It is contemplated that the sound drivers (210, 220 and 230) can be powered by any suitable power source, e.g., a battery 250 (preferably a lipo-battery) with a charging port 251, or an outside power source connected to the earbud 200 by wire. The earbud 200 can be controlled by a control panel (e.g., a haptic driver 240). The earbud 200 can be connected to an audio output through a wire or by a wireless system (e.g., Bluetooth™). The ear hook 204 can also have an antenna to receive a wireless signal from an audio output.

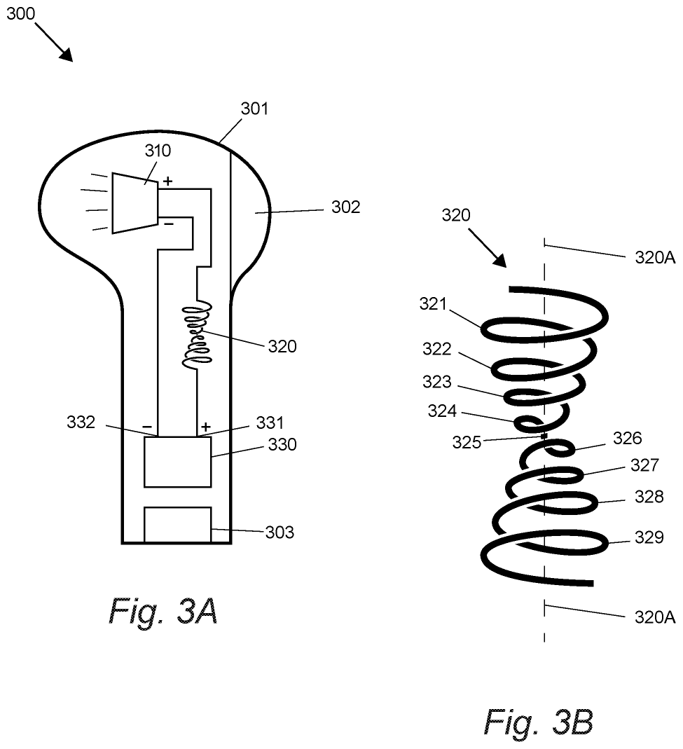

In FIG. 3A, the speaker system 300 has a shape of an earbud and has a speaker 310, a scalar coil 320, and a sound chip 330. The scalar coil 320 is coupled to and in series with the speaker 310 and the sound chip 330. The scalar coil 320 (an enlarged view shown in FIG. 3B) is a single strand of wire having two separate spiral windings that each winds in a continuous and gradually widening curve, about a center axis 320A so as to form a cone. The first spiral winding (on the top) has four turns 321-324, and the second spiral winding (on the bottom) also has four turns 326-329. The two spiral windings are connected at a center 325 and are symmetrical to each other with respect to the center 325. It is contemplated that in other embodiments, the spiral windings could have more turns, or fewer turns.

As shown in FIG. 3B, the second segment (326-329) of scalar coil 320 winds in an opposite direction to the first segment (321-324), when viewed from the wider end 321 of the first segment (i.e., from the top). In other words, the top spiral (326-129) winding winds in a clockwise direction, when viewed from its wider end near 321 (i.e., from the top). The bottom spiral winding (326-329) winds in a counterclockwise direction, when viewed from wider end near 321 of the top spiral winding (i.e., from the top). Contemplated scalar coils can be flattened pancake coils (i.e., two dimensional) but can also be stretched into an elongated form (i.e., three dimensional).

Preferably, the scalar coil 320 is connected to the positive terminal of the speaker 310 and the sound chip 330. The sound chip 330 is an integrated circuit (i.e. “IC”) designed to produce a sound signal. It can do so through digital, analog or mixed-mode electronics. Contemplated sound chips could contain oscillators, envelope controllers, samplers, filters and amplifiers. The sound chip 330 has a sound output. The positive terminal 331 of the output is in series with the scalar coil 320, and the negative terminal 332 is in series with the speaker 310. It is contemplated that the speaker system 300 has a control panel 302 (e.g., electronic deck) and a multi-functional switch 103 that can be used by a user to exercise control over the speaker 310.

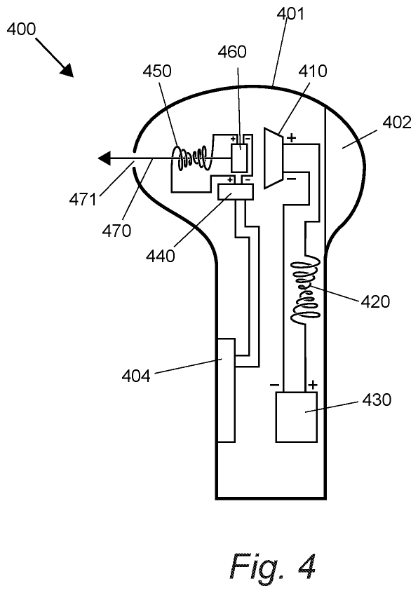

FIG. 4 shows a preferred embodiment of a speaker system 400 having a speaker 410, a scalar coil 420 in series with the speaker 410, and a sound chip 430, a laser device (440 and 460), and a scalar coil 450 in series with the laser device. The laser device has a laser driver 440 and a laser emitter 460. The laser emitter 460 is positioned to produce a laser beam 470 that travels through the scalar coil 450. The speaker system 400 has a housing 401 with an outlet 471 that is transparent to sound waves and to electromagnetic radiation. After passing the scalar coil 450, the laser beam 470 travel towards the outlet 471 after passing the elongated scalar coil 450. The outlet 471 can be an opening in the housing 401. It is contemplated that, when the speaker system 400 is worn in a user's ear, the outlet 471 would be near the user's ear canal, so that the laser beam 470 would shine into the user's ear canal.

Preferably, the laser beam 470 passes through the scalar coil 450 winding passes through the center of the coil in an orthogonal configuration. In other words, the laser beam 470 passes through the scalar coil 450 along its axis (e.g., 320A in FIG. 3B). In preferred embodiments, the scalar coil 450 is wired in series to the laser emitter 460 at the positive terminal if it is DC driven. The scalar coil 450 can be wired in series to the laser emitter 460 at either the positive or negative terminal if it is AC driven. It is contemplated that the laser beam 470 can change its phase (e.g., by 180 degrees) or any phase shift compared to the audio driver or the other laser driver after it passes through the scalar coil 450. The laser driver 440 and emitter 460 can be configured to emit lasers of any wavelength, preferably with wavelengths between 645 nm and 655 nm.

The audio system in FIG. 4 is similar to the audio system in FIG. 3A. The audio signal output 430 is run through a separate coil 420 which can be wound in a near exact path to the laser coil 450, but maintains its own circuit. The audio coil 420 is in series with the positive output of the audio output to the speaker 410. The speaker 410, audio IC 430, laser driver 440, and laser emitter 460, are powered by a battery 404 that is in the housing 401 of the speaker system 400. It is also contemplated that an outside power source can be used to power the electronic equipment. Moreover, the audio system 400 can be controlled a control interface 402, for example, an electronic deck.

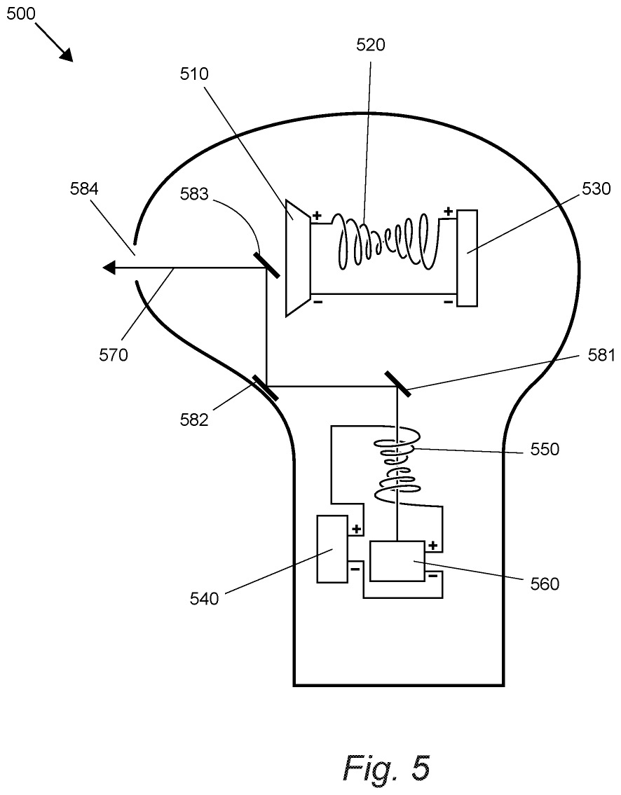

The earbud in FIG. 5 is similar to the earbud in FIG. 4, but the positions of the laser system and audio systems are different. In FIG. 5, the laser beam 570 produced by the laser emitter 560 is guided with a set of reflectors 581-583 to reach the outlet 584. Contemplated reflectors can be a mirror or other reflective surfaces that can be used to change the course of the laser beam 570. It is also contemplated that the laser beam 570 can be guided by a waveguide, or travel inside a fiber-optic cable to reach the outlet 584.

Recent research has found that a user's voice can only emit sounds which the user's ear can register. As voice and hearing are intrinsically linked via the nervous system, Inventors believe that the vocal characteristics can be used as data that can be applied to determine audio spectrum hearing capabilities of a person. In embodiments of the inventive concept vocal data is used to create an enhanced audio environment for a user, through by analysis of frequency data obtained from the user's voice and generation of a unique audio filter that matches the outlier frequency ranges found in the vocal analysis.

In some embodiments, a voice frequency-based equalization system transforms the user's voice via Fast Fourier Transform (FFT) and/or Fractal analysis to determine unique vocal features which indicate a user's unique hearing profile. However, it is contemplated that any type of analysis known in the art can be employed to analyze a voice. Based on one or more analyses, the present invention contemplated creates a preset audio configuration for a user that enhances the sound and overall audio experience of the user.

In preferred embodiments, the preset audio configuration is loaded onto a storage device (such as an audio player) coupled to an earbud, speaker, and/or headset, and is time stamped as a unique filter for that user at the time of recording. As such, all audio played on the earbuds, the speaker, or the headset can be filtered by this filter for the enhancement of the audio to cater to the user's unique hearing and vocal profile. It is contemplated that the user can at any time re-record, and the preset will change according to the most recent FFT analysis.

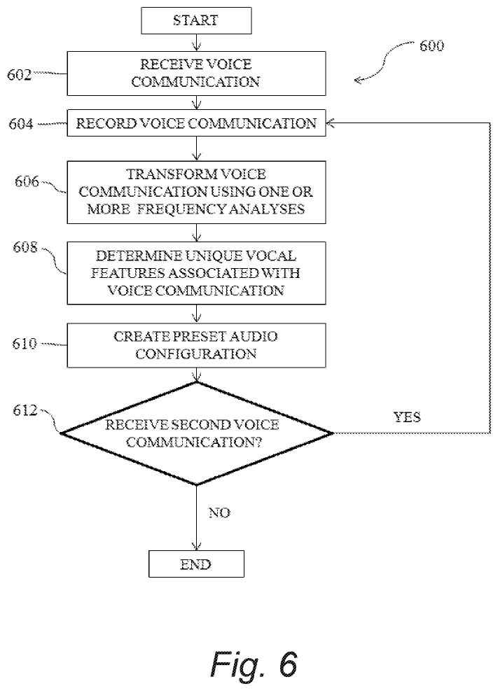

An example of a method of the inventive concept (600) is shown schematically in FIG. 6. As shown, a voice communication and/or vocal data is initially received from a user (602), for example from a microphone or similar device. This vocal communication and/or data is recorded (for example, by storage in a suitable digital database). The recorded vocal data is analyzed to determine a frequency distribution (606). For example, vocal data can be subjected to Fourier Transform analysis and/or Fractal analysis in order to identify a frequency distribution of the recorded vocal data (for example, by identifying peaks and/or troughs in frequency intensity, identifying deviations from a stored default frequency distribution, etc.), which in turn permits determination of vocal features characteristic of and/or unique to the user (608). The determined frequency distribution and/or characteristics vocal features can be stored in an appropriate database, and made available to a processor.

The characteristic and/or unique vocal features can be used by a processor to generate a preset audio configuration (610) that can act as an audio filter. For example, if the user's vocal data indicates a hearing loss within a particular frequency range the preset audio configuration can act as an audio filter that increases speaker output within that frequency range. Alternatively, if the user's characteristic and/or unique vocal features indicate a substantial loss of hearing within one or more frequency ranges the preset audio configuration can act as an audio filter that compresses or redistributes the output of an audio file to preferentially fall within an audio range that is readily perceived by the user.

In some embodiments a user may elect to repeat the process, generating a second voice command and/or vocal data set that is similarly processed (612). In such an embodiment the second voice command and/or vocal data set can be used to generate a new preset audio configuration that replaces one generated earlier. In other embodiments the second voice command and/or vocal data set can be used to modify and earlier preset audio configuration in order to provide a more sophisticated or accurate audio filter.

An earbud of the inventive concept can include a housing or body that is in contact with and/or at least partially inserted into an ear of a user when in use. Such a housing can be constructed of one or more materials suitable for contact with human skin, and can have different compositions in different regions of the housing. For example, portions of the housing that are exposed when in use can be constructed of one or more rigid materials (e.g. hard plastic, metal, ceramic, etc.) whereas portions that are inserted into the ear canal can be constructed of one or more pliant materials (e.g. silicone rubber, latex, polyurethane, etc.). In some embodiments an earbud of the inventive concept can include a hook or similar projection that engages with the concha of the ear, improving stability and proper positioning of the earbud. The housing of the earbud can also support one or more control features that can be used to control earbud functions. In a preferred embodiment a portion of the body or housing can extend downwards in a stem or stalk.

Such an earbud can include a power supply (such as a battery) and one or more speakers, and is in communication with a source of audio and/or video files for playback through the earbud. Such audio and/or video files can be stored on memory within the earbud, or can be stored on memory in an external device (such as a computer, telephone, or portable audio player). In embodiments where audio and/or video files are stored in an external device the earbud can include an antenna, circuitry, and appropriate processing to support wireless communication (e.g. BlueTooth, WiFi, etc.). Alternatively or in addition to such wireless circuitry, and earbud of the inventive concept can include a port that supports a wired connection. Earbuds of the inventive concept can also include an antenna and associated circuitry to support wireless charging of an onboard power supply, for example by magnetic induction.

In preferred embodiments, the earbuds comprise a main body portion with an extended curvature configuration. In one example, the earbuds include a speaker housing separated into a divided group of isobaric sound chambers and an extension that couples the isobaric sound chambers via a transmission line to form a waveguide between the speaker housing and the extension.

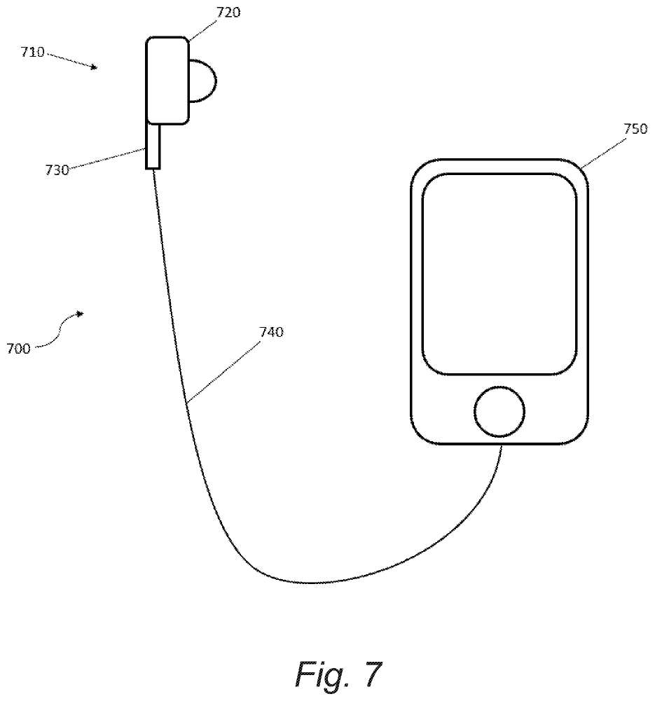

An example of a system of the inventive concept (700) is shown in FIG. 7. As shown the system includes an earbud (710) or headphone component that is positioned at or within the ear of a user. Such earbud can include a housing (720), which can enclose one or more speakers. In some embodiments the housing can also enclose or define one or more resonating or isobaric chambers that aid in acoustic performance. The housing can also include a stem (730) or similar extension. Such a stem can include a microphone, the microphone being positioned for receiving vocal sounds from a user when the earbud is in use. In other embodiments the microphone can be included in or on the portion of the body that encloses the speaker and/or a resonating chamber.

The earbud (710) can be connected to an audio player (750), for example using a cable (740). In some embodiments, connections to the audio player can be accomplished using a wireless technology, (e.g, BlueTooth, WiFi, etc.). The audio player (750) provides storage for audio files, and can incorporate one or more processors utilized to process vocal data received from the microphone and to generate audio files that are modified based on the vocal data. The audio player (750) can also include storage for one or more databank(s) for storing vocal data, instructions for utilizing vocal data to generate an audio filter and/or application of such an audio filter to generate modified audio file, and/or modified audio files.

While such features and functions can be incorporated into an audio player, it should be appreciated that one more of such features and functions can be incorporated into an earbud, a pair of earbuds, and/or a headset. For example, and earbud of the system can include a processor that is in communication with the microphone and is used to analyze vocal data. In such an embodiment the audio player can include a second processor that utilizes the results of such analysis to generate modified audio files.

In other embodiments, all processing occurs within an earbud, pair of earbuds, and/or headphones, and the portable audio player is essentially used for storage of unmodified and/or modified audio files. In such embodiments the earbud, pair of earbuds, and/or headset can be utilized between two or more audio players. Such audio player can be generic and not include system-specific components, essentially providing only storage and transmission of audio files. Alternatively, in some embodiments all of the components for the system can be incorporated into the earbud, pair of earbuds, and/or headset; such a system may not include a separate and distinct audio player.

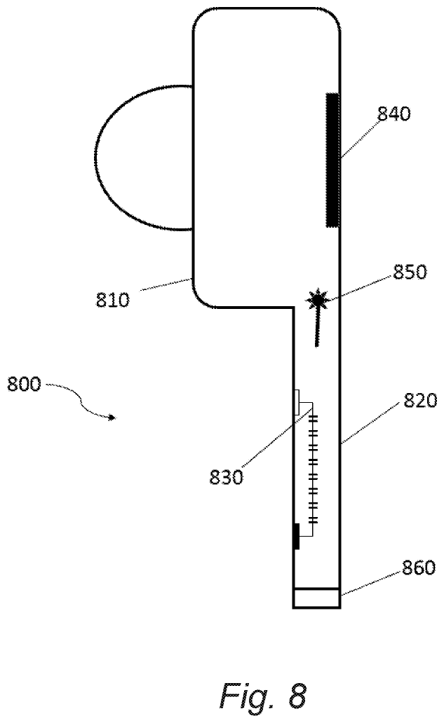

An example of an earbud of the inventive concept (800) is shown in FIG. 8. As shown, the earbud has a housing (810) from which extends an elongated shaft (820). A capacitive sensor array (830) is positioned within the shaft, where it is readily accessible for contact by a user's finger. In a preferred embodiment the capacitive sensor array includes a series of capacitors arranged as a “bucket brigade”. Members of this series of capacitors can be of different sizes, compositions, and/or configurations, such that the capacitor array can be responsive to a wide range of contact or near-contact events (e.g. contact or near contact with a finger of a user). Such near-contact events provide sufficient proximity to generate a response from the array without actual contact with the earbud. The capacitive sensor array (830) is in communication with and provides input to a microprocessor (840), for example in the form of one or more electronic pulses, change in RC time constant (i.e. τ) and/or frequency, in response to proximity of an electrical field (e.g. due to contact or near contact with a user's finger). In some embodiments the controller can be enclosed within the housing.

Input from the capacitive sensor array is utilized by the processor to generate outputs that control various functions of the earbud. For example, data from the capacitive sensor array can be used to start playing of an audio and/or video file, pause playing of an audio and/or video file, skip or select and audio and/or video file, repeat an audio and/or video file, change volume, and/or select an audio filter.

In some embodiments data from the capacitive sensor array (830) is by the processor (840) to provide outputs to a light source (850) within the earbud. Suitable light sources include one or more LEDs, lasers, and/or solid state lasers. Such light sources can be positioned to direct their output towards a cap (860) positioned at or near the terminus of the stem (820). Such a cap can be transparent, translucent, or opaque. In some embodiments the cap can have a reflective internal surface that redirects output from the light source within the earbud, where it can interact with other earbud components. In some of such embodiments the use of a reflective cap provides a desired time delay for one or more emitted pulses of light. The output of the light source (850) can be controlled by the processor (840) to provide a variety of functions, including providing a visual indication of earbud status, providing a visual indication of a received command gesture from a user, and/or enhancement of the user's listening experience (for example, in providing consciously or subconsciously perceived lighting effects).

In some embodiments of the inventive concept an array of capacitive switches (such as a bucket brigade array) is positioned on or within a stem or shaft extending from a main body of an earbud. Such an array can be linear (i.e. having a single column or row of capacitor elements) or two dimensional (i.e. having a plurality of capacitor elements arranged across both length and width). In such an array capacitor elements can be identical. Alternatively, such an array can include two or more capacitor elements having different physical and/or performance characteristics. In such an embodiment, for example, an array of capacitor elements can be provided that have a variety of sizes, dimensions, and/or material compositions. These advantageously provide such an array with a range of sensitivity to externally applied electric fields (such as those generated by proximity to or contact with a user's finger). While the array of capacitive switches is preferentially positioned on or in a stem extended from the body of the earbud, in some embodiments all or a portion of the array can be positioned on or in the body of the earbud (i.e. the portion of the earbud in contact with the concha of the ear when inserted).

In some embodiments the earbud can utilize sensor data obtained from the array of capacitive switches, other sensing elements, or a combination of these to functionally isolate specified capacitor elements from the array. This provides a mechanism for adjusting the sensitivity of the array to suit the position or local environment of the earbud.

Data from the array of capacitive switches is generated by contact with and/or proximity to the users skin surface (typically a portion of the users finger). This allows a user to activate a microcontroller input-ouput (I/O) interface that is in communication with the capacitor array. In preferred embodiments, activating the microcontroller I/O interface is accomplished by contacting the array of capacitive switches (or coming into sufficient proximity) to cause one or more electrical signals to be sent to the microcontroller.

It is further contemplated that the RC constant (τ) is altered by user skin surface proximity to the array (e.g, through physical contact or close proximity) and can affect the switching of the input ports on a processor (such as a microcontroller). This switching can generate commands from the processor to an audio and/or video player. Examples of suitable commands include initiating playback of a stored file, pausing playback, terminating playback of a first file and initiating playback of a second file from a playlist, initiating receipt of a voice command, initiating a telephone call, initiating a text message, and so on. Additionally, it is also contemplated that devices of the inventive concept can produce a frequency shift in an oscillator circuit to activate a processor coupled to a microcontroller I/O interface.

It should be appreciated that such a bucket brigade arrangement of a capacitor array advantageously allows for different capacities or frequencies to provide data to processor and/or microcontroller, thereby enhancing the sensitivity and range of a control system utilizing same.

In a preferred embodiment the array of capacitive switches is paired with a light source (such as an LED or laser) that is controlled by a processor and/or microcontroller that receives data from the array. Data provided from the array of capacitive switches can be utilized by the processor and/or microcontroller in determining output that is provided to the light source.

In such embodiments the light source can be positioned to direct output light towards the lower portion or bottom of the stem or shaft of the earbud. This lower portion or end can be fitted with a cap, which can be transparent, translucent, or opaque. Light emitted through the cap can be used for a variety of purposes. For example, such emitted light provides information regarding the status of the earbud (battery status, wireless connectivity status, etc.). Alternatively, such emitted light can be directed so as to be perceived (either consciously or subconsciously) by the user, so as to enhance their listening experience. In some embodiments the interior of such a cap can be reflective, directing at least a portion of the light emitted by the light source to other components of the earbud. In such embodiments the reflected light can provide communication, data, or instruction transmission between the microprocessor and the components.

As noted above, the capacitive switch modality is installed vertically on the shaft of the earbud assembly. In preferred embodiments, the earbuds comprise a main body portion with an extended curvature configuration. In one example, the earbuds include a primary body that is contact with concha of the ear and can be at least partially inserted into the ear canal when in use. Such a body can include speaker housing separated into a divided group of isobaric sound chambers and an extension that couples the isobaric sound chambers via a transmission line to form a waveguide between the speaker housing and the extension.

The inventive subject matter also provides apparatus, systems, and methods in which an earbud shaft comprises a rotary switch to provide a control mechanism. In some embodiments of the inventive concept, rotary switch is positioned on a stem or stalks that extends from an earbud. This rotary switch allows a user to provide instructions to a processor and/or microcontroller, and so serves as at least a portion of an input-ouput (I/O) interface. The rotary switch can be an analog switch or a digital switch. In preferred embodiments, activating the I/O interface is accomplished by rotating a spring loaded disc positioned at the bottom or terminal portion of the shaft. While rotating momentary contact is made with contact surfaces, which in turn results in signals being sent to the processor or microcontroller.

In some embodiments, the earbud can also include a pressure sensitive switch. In a preferred embodiment, the rotary switch can incorporate or form a portion of a push up contact switch located in the same assembly. Such a pressure sensitive switch can be used to activate an additional contact in order to provide additional signals to the processor or microcontroller. For example, application of pressure to such a pressure sensitive switch can act to turn the earbud on and/or off via the processor or microcontroller.

In preferred embodiments, the earbud has a housing or main body portion with an extended curvature configuration. In one example, the earbud includes a speaker housing that is separated into a divided group of isobaric sound chambers and an extension that couples the isobaric sound chambers via a transmission line to form a waveguide between the speaker housing and the extension.

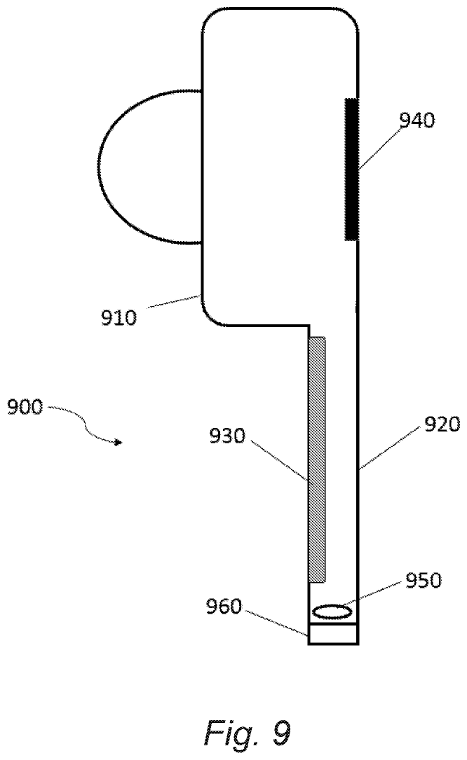

An embodiment of an earbud of the inventive concept is shown in FIG. 9. As shown, such an earbud (900) can have a housing (910) from which a stem or stalk (920) extends. The stem or stalk can enclose a power source (930), such as a battery, that provides electrical power to a processor or microcontroller (940) as well as other components of the earbud. In some embodiments the processor or microcontroller is positioned within a portion of the housing (910) that is in contact with the concha of the ear of a user when the earbud is in place.

Such an earbud (900) can also include control mechanisms in the form of rotary and pressure switches positioned at the terminus of the stem or stalk (920). As shown in FIG. 9, the stem or stalk can include a rotary switch (960), where the rotary switch can be easily accessed and manipulated. In some embodiments the rotary switch (960) is a discrete device positioned at the terminus of the stem or stalk. In other embodiments all or part of the stem or stalk can be rotated to activate the rotary switch.

The stem or stalk (920) can also include a pressure sensitive switch (950), which can be triggered by application of pressure. Such a pressure sensitive switch can be oriented to be activated by pressure applied to the terminus of the stem or stalk (920) and directed along the long axis of the stalk or stem and towards the housing (910). In such an embodiment the rotary switch (960) can be mounted on a pliant or spring-loaded coupling that permits movement towards the rotary switch (950). In such an embodiment the rotary switch (950) can be activated by applying pressure to the rotary switch (960) in a direction perpendicular to the plane of its rotation. In other embodiments the pressure sensitive switch (950) can be positioned and oriented to be activated by pressure applied at right angles to the long axis of the stem or stalk, for example by using a pinching grip on the stem or stalk. In such embodiments the stem or stalk can be constructed of or include a pliant material that permits sufficient compression to activate the pressure sensitive switch.

Both the pressure sensitive switch (950) and the rotary switch (960) are in communication with the processor or microcontroller (940), and can be used to control functions of the earbud. In preferred embodiments the pressure sensitive switch (950) can be used to switch the earbud between on and off modes, between on and sleep modes, and/or between on, sleep, and off modes. Towards that end the microprocessor can include an algorithm that permits pattern recognition of signals received from the pressure sensitive switch. For example, a single activation can indicate switching between on and sleep modes, whereas two activations in rapid succession can indicate switching between on and off modes. Other functions, such as file selection, initiation of voice commands received through a microphone, pairing and unpairing of wireless connections, etc. can be similarly encoded by rhythms applied to the pressure sensitive switch.

In some embodiments, the rotary switch (960) can be used to adjust volume of sound output from the earbud, fast forward playback through the earbud, rewind playback through the earbud, skip forward to play a different stored file, and skip backward to play a different stored file. In some embodiments instructions from the user can be conveyed to the processor and/or microcontroller using a combination of inputs from the pressure sensitive switch and the rotary switch. In embodiments application of pressure to activate the pressure switch while turning the rotary switch can access different functions than rotation of the rotary switch in the absence of activation of the pressure switch. For example, rotation of the rotary switch without activation of the pressure switch can provide volume control, while rotation of the rotary switch with activation of the pressure switch can provide file navigation (e.g. file skipping, fast forward, reverse playback, etc.). This can be implemented conveniently in embodiments where the rotary switch incorporates or forms part of the pressure switch.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1-76. (canceled)

77. A speaker system, comprising:
a speaker; and
a first elongated coil coupled to the speaker, and comprising first and second spiral windings, wherein:
each of the first and second spiral windings are in series with an input of the speaker; and
the first and second spiral windings are wound in opposite directions.

78. The speaker system of claim 77, wherein the first spiral winding is symmetrical with the second spiral winding.

79. The speaker system of claim 77, wherein the first spiral winding shares a center with the second spiral winding.

80. The speaker system of claim 77, wherein the first spiral winding shares a central axis with the second spiral winding.

81. The speaker system of claim 77, further comprising a second elongated coil coupled to the laser emitter, wherein the second elongated coil comprises oppositely wound third and fourth spiral windings.

82. The speaker system of claim 81 further comprising a laser emitter configured to produce a laser beam directed to travel through a pathway defined by the second elongated coil.

83. The speaker system of claim 82, further comprising a housing comprising an outlet, wherein the outlet is transparent to sound waves and electromagnetic radiation, and wherein the laser beam is configured to travel through the second elongated coil before traveling through the outlet.

84. The speaker system of claim 81, wherein the third spiral winding shares a central axis with the fourth spiral winding.

85. A speaker system, comprising:
a speaker;
a laser emitter configured to emit a laser beam into a user's ear canal; and
an elongated coil coupled to the laser emitter, wherein the elongated coil comprises a first spiral winding and a distinct second spiral winding, wherein the first and second spiral windings are wound in opposite directions.

86. The speaker system of claim 85, wherein the first and second spiral windings are symmetrical to each other with respect to a center.

87. The speaker system of claim 85, further comprising a laser emitter configured to produce a laser beam directed to travel through a pathway defined by the second spiral winding.

88. The speaker system of claim 85, wherein the speaker system is housed in an earbud body, and is configured to fit around a root of an ear pinna of a user.

89. The speaker system of claim 85, further comprising a capacitive control interface that includes a touch-sensitive capacitive sensor configured to control one or more aspects of sound emitted by the speaker.

90. The speaker system of claim 89, wherein the capacitive sensor is arrayed in a two dimensional array with other capacitive sensors.

91. The speaker system of claim 89, wherein the capacitive sensor is arranged with other capacitive sensors as a bucket brigade circuit.

92. The speaker system of claim 85, further comprising a stem, a rotary switch in or on the stem, and a pressure switch in or on the stem, and a processor configured to execute program instructions in response to signals from the rotary and pressure switches.

93. The speaker system of claim 92, wherein the program instructions are selected from the group consisting of: a fast forward instruction, a rewind instruction, a skip forward instruction, and a skip backward instruction.

94. The speaker system of claim 92, wherein the program instructions include a sleep instruction.
